(19) United States
(12) Patent Application Publication
(10) Pub. No.: US 2023/0414054 A1
(43) Pub. Date: Dec. 28, 2023

(54) COLLISION DETECTION APPARATUS AND CLEANING DEVICE

(71) Applicant: Beijing Xiaomi Mobile Software Co., Ltd., Beijing (CN)

(72) Inventor: Erdong GU, Beijing (CN)

(21) Appl. No.: 17/937,316

(22) Filed: Sep. 30, 2022

(30) Foreign Application Priority Data
Jun. 24, 2022 (CN) 202221594236.9

(51) Int. Cl. A47L 11/40; A47L 11/24

(52) U.S. Cl. CPC A47L 11/4061; A47L 11/24

(57) ABSTRACT

A collision detection apparatus includes: a base; a switch in the base; an elastic assembly disposed in the base, in which one end of the elastic assembly is connected with the base, and the other end is connected with the switch; and a cover, one side of which is movably connected with the base to move within a set range and is provided with an abutting part, in which the abutting part is clamped with a preset portion of the elastic assembly; under a state that the cover has a collision and moves in a set direction, the abutting part is forced to push the preset portion, so as to drive the other end of the elastic assembly to trigger the switch, and the switch is configured to report a collision event when being triggered.

### CROSS REFERENCE TO RELATED APPLICATION

The present application claims priority to Chinese Patent Application No. 202221594236.9, filed on Jun. 24, 2022. The entire contents of the above-listed application are hereby incorporated by reference for all purposes.

### BACKGROUND

With the development of technologies, smart home products are applied more and more extensively, such as the application of cleaning devices like a sweeping robot. The sweeping robot usually uses a sensor such as a Laser Distance Sensor (LDS) for automatic navigation so as to achieve cleaning and dust absorption of the floor. The LDS is generally located at the highest position of the sweeping robot, and a height of the LDS determines the ability of the sweeping robot to enter a low space.

During the operation of the sweeping robot, collision detection is used to avoid or bypass obstacles. In the related art, structures for collision detection of the sweeping robot are relatively complex and need to be improved.

### SUMMARY

The disclosure relates to the field of cleaning devices, in particular to a collision detection apparatus and a cleaning device.

According to a first aspect of an example of the disclosure, a collision detection apparatus is provided, including:
a base;
a switch, in the base;
an elastic assembly, disposed in the base, where one end of the elastic assembly is connected with the base, and the other end is connected with the switch; and
a cover, movably connected with the base to move within a set range, where the cover has an abutting part, and the abutting part is clamped with a preset portion of the elastic assembly; where
under a state that the cover has a collision and moves in a set direction, the abutting part is forced to push the preset portion, so as to drive the other end of the elastic assembly to trigger the switch, and the switch is configured to report a collision event when being triggered.

According to a second aspect of an example of the disclosure, a cleaning device is provided, including the collision detection apparatus described in the first aspect.

It can be understood that the above general descriptions and the following detailed descriptions are illustrative and explanatory, and are not intended to limit the disclosure.

### BRIEF DESCRIPTION OF THE DRAWINGS

The accompanying drawings here, which are incorporated in and constitute a part of this specification, illustrate examples consistent with the disclosure and, together with the specification, serve to explain the principles of the disclosure.

FIG. 1 is a schematic diagram of a collision detection apparatus according to an example of the disclosure.

FIG. 2 is a schematic diagram of a collision detection apparatus according to an example of the disclosure.

FIG. 3 is a schematic diagram of a cover according to an example of the disclosure.

FIG. 4 is a schematic diagram of a base according to an example of the disclosure.

FIG. 5 is a top view of a collision detection apparatus according to an example of the disclosure.

FIG. 6 is a top view of a base according to an example of the disclosure.

FIG. 7 is a top view of a base according to another example of the disclosure.

### DETAILED DESCRIPTION

Examples will be described in detail herein, instances of which are illustrated in the accompanying drawings. When the following description refers to the accompanying drawings, the same numerals in different accompanying drawings refer to the same or similar elements unless otherwise indicated. The implementations described in the examples below are not intended to represent all implementations consistent with the disclosure. Rather, they are merely instances of apparatuses and methods consistent with some aspects of the disclosure.

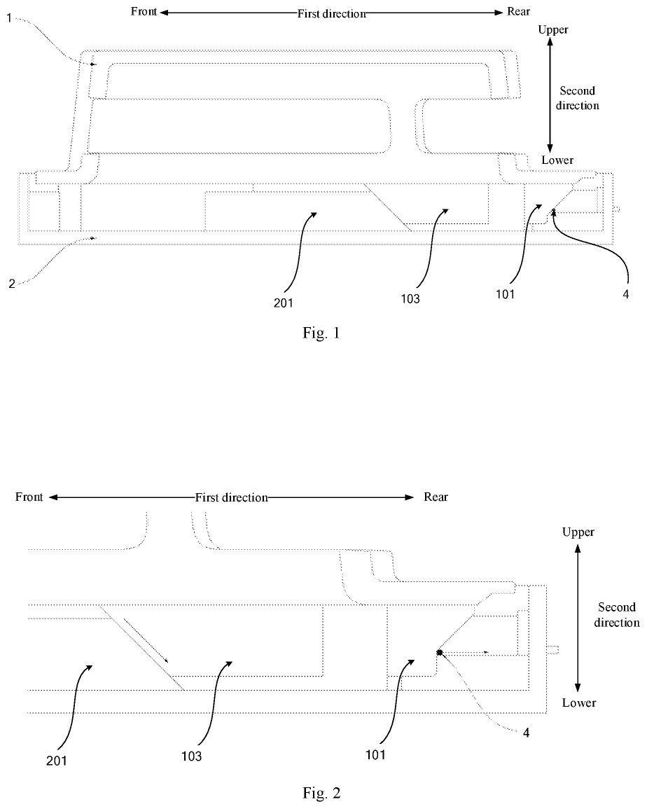

In an example, as shown in FIG. 1 to FIG. 7, a collision detection apparatus includes a cover 1, a base 2, a switch 3 and an elastic assembly 4.

The switch 3 is disposed in the base 2. The elastic assembly 4 is disposed in the base 2, one end of the elastic assembly 4 is connected with the base 2, and the other end of the elastic assembly 4 is connected with the switch 3. One side of the cover 1 is movably connected with the base 2 to move within a set range. An abutting part 101 is disposed on one side of the cover 1, and the abutting part 101 is clamped with a preset portion of the elastic assembly 4. Under a state that the cover 1 has a collision and moves in a set direction, the abutting part 101 is forced to push the preset portion, so as to drive the other end of the elastic assembly 4 to press and trigger the switch 3, and the switch 3 is configured to report a collision event when being triggered.

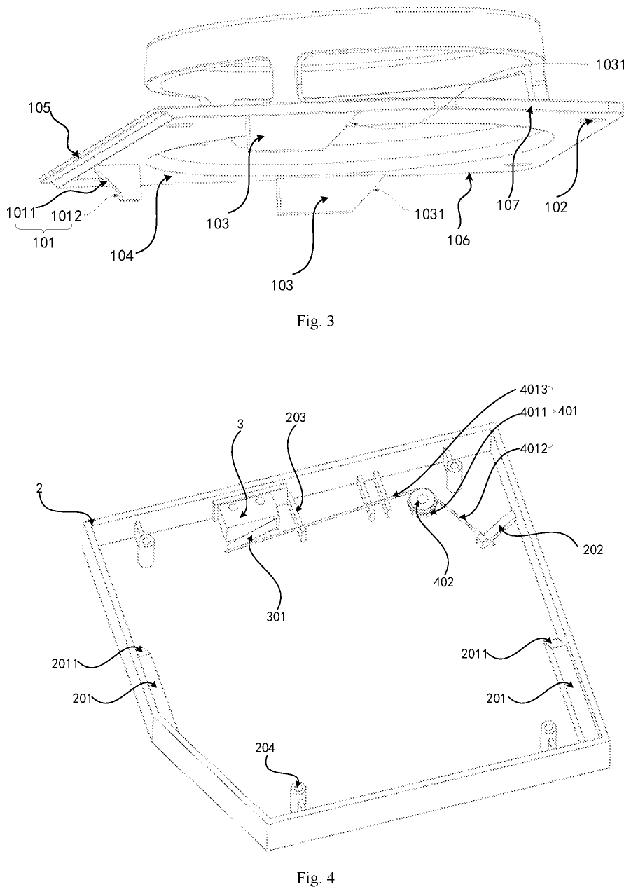

In an example, as shown in FIG. 1 and FIG. 3, a first side of the cover 1 is assembled with the base 2, and a second side of the cover 1 may form a protruding protective cover. In the example of the disclosure, taking a cleaning device being a sweeping robot as an example for description. A laser distance sensor (LDS) of the sweeping robot may be disposed in the protective cover, and the cover 1 can realize the protection of the LDS and can also improve the aesthetics of the sweeping robot. As shown in FIG. 1 or FIG. 3, the protective cover of the cover 1 may be provided with a notch to reduce the weight and not affect the detection of the LDS. The cover 1 includes a bottom plate 104, a hollowed-out region is disposed in a central portion of the bottom plate 104, and the hollowed-out region communicates with the notch on the protective cover.

In an example, as shown in FIG. 4, a containing cavity may be formed inside the base 2 and is configured to contain circuit components (not shown in the figure) of the sweeping robot, the switch 3 and the elastic assembly 4. Both the switch 3 and the LDS are in communication connection with a processor or main controller of the sweeping robot. When the switch 3 is triggered, the collision event will be reported to the processor or the main controller, so that the processor or the main controller can control the sweeping robot to avoid obstacles.

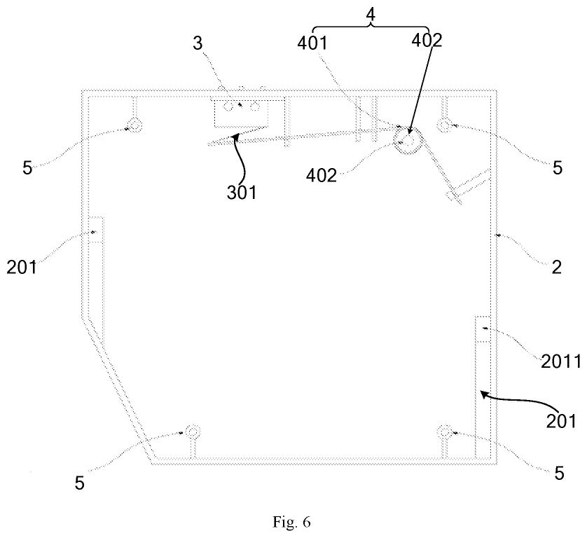

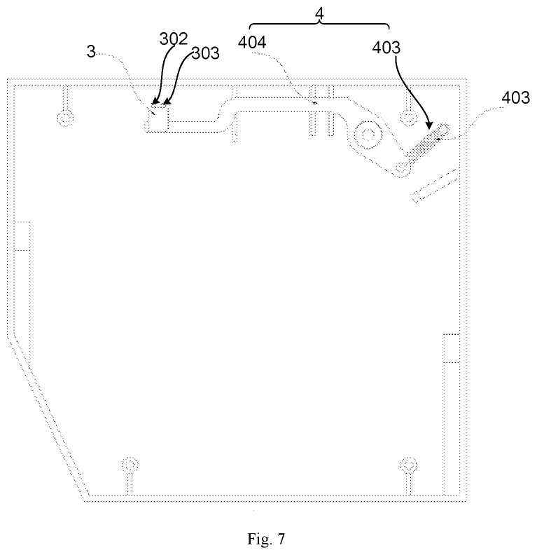

Referring to FIG. 6 or FIG. 7, the switch 3 may be either a mechanical switch or a photoelectric switch. As shown in FIG. 4, one end of the elastic assembly 4 is connected with the base 2, and the other end of the elastic assembly 4 is configured to trigger the switch 3 during the collision.

In an example, the cover 1 is connected with the base 2, and may move relative to the base 2 within a set range under a connection state. Referring to FIG. 1, combined with a direction in which the sweeping robot has a collision, the set range includes: moving by a set distance in the set direction.

The set direction includes a first direction or a second direction. When the sweeping robot moves, the first direction is also a moving direction of the sweeping robot in a horizontal direction. The second direction may be a vertical direction. The set range includes, for example, moving by a first distance in the first direction, and/or moving by a second distance in the second direction.

In one example, when the front of the sweeping robot has a collision, the cover 1 may move backwards in the first direction, and the abutting part 101 of the cover 1 is configured to push and squeeze the preset portion of the elastic assembly 4, so as to trigger the switch 3 through the elastic assembly 4.

In another example, when the top (upper portion) of the sweeping robot has a collision, the cover 1 may move downwards in the second direction, and the abutting part 101 of the cover 1 is configured to push and squeeze the preset portion of the elastic assembly 4, so as to trigger the switch 3 through the elastic assembly 4.

In the collision detection apparatus of the disclosure, the abutting part 101 disposed on the cover 1 is matched with the elastic assembly 4, when a collision external force exists, the abutting part 101 moves to drive the elastic assembly 4 to move so as to trigger the switch 3, so that the switch 3 can report the collision event in time when being triggered. In the disclosure, the structure is simple, and the collision detection sensitivity and efficiency are high.

In an example, as shown in FIG. 1 to FIG. 7, in the collision detection apparatus of the an example, a plurality of limiting holes 102 are formed in the bottom plate 104 of the cover 1, and the cover 1 is movably connected with the base 2 through the limiting holes 102.

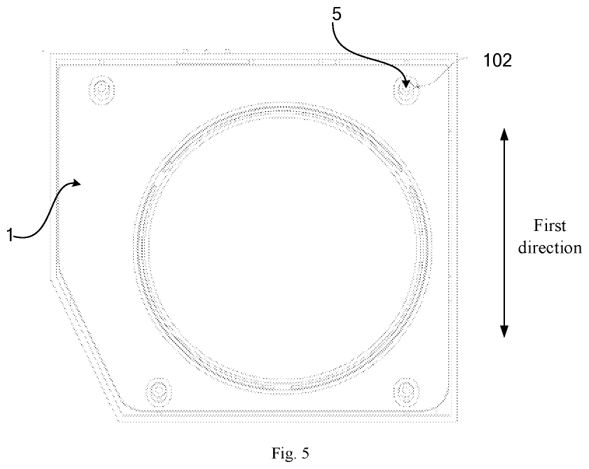

In an example, as shown in FIG. 5, the plurality of limiting holes 102 may be formed at intervals in a circumferential direction of the bottom plate 104 of the cover 1, and the cover 1 and the base 2 are movably connected by the limiting holes 102 in the cover 1.

In an example, the collision detection apparatus further includes first fixing pieces 5, one ends of the first fixing pieces 5 are assembled with the limiting holes 102, and the other ends of the first fixing pieces 5 are fixedly connected with the base 2, so as to connect the cover 1 with the base 2. The first fixing pieces 5 may be screws, one ends of the screws are assembled with the limiting holes 102 in a limited manner, and the other ends of the screws are fixedly connected with bolt columns 204 on the base 2.

In an example, the limiting holes 102 extend by a first distance in the first direction, so that the cover 1 can move by the first distance in the first direction. As shown in a direction of FIG. 5, under an assembled state of the screws and the limiting holes 102, an extending distance of each limiting hole 102 in the first direction is greater than a diameter of the corresponding screw, so that the cover 1 can move by the first distance in the first direction, for example, the limiting holes 102 may be racetrack-type holes.

In an example, as shown in FIG. 1 to FIG. 7, in the collision detection apparatus, the abutting part 101 includes an inclined unit 1011 and a vertical unit 1012 which are connected, and under a state of no collisions, a clamping structure formed by the inclined unit 1011 and the vertical unit 1012 is clamped with the preset portion. The inclined unit 1011 is configured to push the preset portion under the state that the cover 1 has a collision and moves in the set direction.

In an example, the set direction includes the first direction or the second direction, and the second direction is the vertical direction. As shown in FIG. 1 to FIG. 3, the abutting part 101 is configured as a wedge-shaped block, an obtuse-angle clamping structure is formed between the inclined unit 1011 and the vertical unit 1012 of the abutting part 101, and the inclined unit 1011 forms a slope. When the sweeping robot has no collisions, the clamping structure is clamped with the preset portion of the elastic assembly 4. When the sweeping robot has a collision, the cover 1 moves to drive the abutting part 101 to move, and the inclined unit 1011 of the abutting part 101 will push the preset portion, so that the elastic assembly 4 triggers the switch 3.

In an example, as shown in FIG. 1 to FIG. 7, in the collision detection apparatus, the cover 1 includes the bottom plate 104, and limiting parts 103 are disposed on the bottom plate 104, and first slopes 1031 are disposed at one ends of the limiting parts 103. Matching parts 201 are disposed at positions, corresponding to the limiting parts 103, of the base 2, and one ends of the matching parts 201 are provided with second slopes 2011. The first slopes 1031 are in sliding contact with the second slopes 2011, so that the limiting parts 103 and the matching parts 201 are in sliding connection.

In the example, when the sweeping robot has a collision from the front or the top (upper portion), the cover 1 will move in the first direction or the second direction. During the movement, the limiting parts 103 can effectively limit a moving distance of the cover 1, and the first slopes 1031 of the limiting parts 103 and the second slopes 2011 of the matching parts 201 are slidably matched, so that the stability of the cover 1 in the relative movement process can be effectively improved. In addition, the sliding cooperation between the first slopes 1031 and the second slopes 2011 is also helpful for the reset of the cover 1 when the collision external force disappears, and for details, please refers to the description of the following examples.

In an example, as shown in FIG. 1 to FIG. 7, in the collision detection apparatus of the example, the abutting part 101 is disposed at a position, at a first predetermined distance from a first side 105 of the bottom plate 104, of the bottom plate 104; and the limiting parts 103 are disposed at a position, at a second predetermined distance from a second side 106 of the bottom plate 104, of the bottom plate 104 and/or at a position, at a third predetermined distance from a third side 107 of the bottom plate 104, of the bottom plate 104, the second side 106 and the third side 107 are oppositely disposed, and the first slopes 1031 are located at one ends, away from the abutting part 101, of the limiting parts 103.

In the example, as shown in FIG. 3, the limiting parts 103 may be disposed on one side, or on the second side 106 and the third side 107 separately. Each side may be provided with either one limiting part 103 or two or more limiting parts 103, so as to further improve the stability of the relative movement of the cover 1 and the reset efficiency.

The abutting part 101 is located on a side of the rear of the cover 1, and the clamping structure formed by the inclined unit 1011 and the vertical unit 1012 in the abutting part 101 faces the elastic assembly 4. The first slopes 1031 of the limiting parts 103 are disposed at one end away from the abutting part 101, and an inclined direction of the first slopes 1031 may match the movement and reset directions of the cover 1.

In combination with movement directions shown by the arrows in FIG. 2, taking the elastic assembly 4 being pushed during the movement of the cover 1 as an example, the first slopes of the limiting parts 103 may slide obliquely downwards from the second slopes 2011 of the matching parts 201, so as to ensure that the cover 1 slides backwards smoothly in the first direction.

In an example, as shown in FIG. 1 to FIG. 7, in the collision detection apparatus, the elastic assembly 4 includes a torsion spring 401 and a second fixing piece 402; the second fixing piece 402 is vertically fixed on the base 2, and the torsion spring 401 is connected to the second fixing piece 402; and the preset portion is a connection portion of the torsion spring 401 and the second fixing piece 402.

The example of the disclosure illustrates the elastic assembly 4 in the form of the torsion spring 401.

In an example, as shown in FIG. 4 and FIG. 6, the second fixing piece 402 may be a structure such as a screw or a stud, and the torsion spring 401 sleeves the second fixing piece 402 so as to be limited and fixed in the base 2. The preset portion may include a main body part 4011 of the torsion spring 401, and the main body part 4011 is in abutting connection with the abutting part 101. When the cover 1 moves due to a collision, the abutting part 101 may push the main body part 4011 to rotate around the second fixing piece 402 to trigger the switch 3.

In an example of the disclosure, the torsion spring 401 includes the main body part 4011, a first arm 4012, and a second arm 4013; the main body part 4011 sleeves the second fixing piece 402, one end of the first arm 4012 is connected with one end of the main body part 4011, and the other end of the first arm 4012 is connected with the base 2; and one end of the second arm 4013 is connected with the other end of the main body part 4011, and the other end of the second arm 4013 is in contact connection with the switch 3. The first arm 4012 and the second arm 4013 extend from the main body part 4011 of the torsion spring 401 respectively, and a length of the first arm 4012 is smaller than that of the second arm 4013. When the cover 1 moves due to a collision, the abutting part 101 may push the main body part 4011 to rotate clockwise around the second fixing piece 402, so that the second arm 4013 triggers the switch 3.

In an example of the disclosure, the base 2 is provided with a first support part 202 and a second support part 203, the first arm 4012 is fixedly connected with the first support part 202, and a set position of the second arm 4013 is in overlap joint with the second support part 203, and the set position is spaced by a third distance from one end of the second arm 4013 for contacting the switch 3. In the example, the set position is, for example, a middle position of the second arm 4013, a middle position of the second arm 4013 is in overlap joint with the second support part 203, and an end portion of the second arm 4013 is in contact with the switch 3. Alternatively, the set position is located between the middle position and one end of the second arm 4013 for contacting the switch 3. The first arm 4012 is snap-fitted or interference-fitted with the first support part 202. Thus, the overlap joint between the second arm 4013 and the second support part 203 can not only effectively support the second arm 4013, but also ensure that the end portion of the second arm 4013 can still move and trigger the switch when the force is applied.

In one example of the disclosure:
as shown in FIG. 1 and FIG. 2, when the front of the sweeping robot has a collision, the cover 1 moves backwards in the first direction, and the inclined unit 1011 of the abutting part 101 pushes backwards the preset portion of the elastic assembly 4. The first arm 4012 of the torsion spring 401 is fixed with the base, the main body part 4011 of the torsion spring 401 rotates clockwise around the second fixing piece 402, an angle between the second arm 4013 and the first arm 4012 becomes larger, and the second arm 4013 triggers the switch 3.

After the collision is eliminated, under the action of the elastic force of the torsion spring 401, the abutting part 101 is pushed to reset, and the first slopes 1031 of the limiting parts 103 in the cover 1 slide relatively with the second slopes 2011 of the matching parts 201, so that the cover 1 ascends to reset.

In another example of the disclosure:
as shown in FIG. 1 and FIG. 2, when the top (upper portion) of the sweeping robot has a collision, the cover 1 moves backwards in the second direction, and the inclined unit 1011 of the abutting part 101 pushes backwards the preset portion of the elastic assembly 4. The first arm 4012 of the torsion spring 401 is fixed with the base, the main body part 4011 of the torsion spring 401 rotates clockwise around the second fixing piece 402, the angle between the second arm 4013 and the first arm 4012 becomes larger, and the second arm 4013 triggers the switch 3.

After the collision is eliminated, under the action of the elastic force of the torsion spring 401, the abutting part 101 is pushed to reset, and the first slopes 1031 of the limiting parts 103 in the cover 1 slide relatively with the second slopes 2011 of the matching parts 201, so that the cover 1 ascends to reset.

In an example, as shown in FIG. 1 to FIG. 7, in the collision detection apparatus, the elastic assembly 4 includes a tension spring 403 and a swing rod 404. One end of the tension spring 403 is fixedly connected with the base 2, the other end of the tension spring 403 is connected with one end of the swing rod 404, and the other end of the swing rod 404 is connected with the switch 3. The preset portion is a connection portion of the tension spring 403 and the swing rod 404.

The example of the disclosure illustrates the elastic assembly 4 in the form of the swing rod 404.

As shown in FIG. 7, when the front or top (upper portion) of the sweeping robot has a collision, the abutting part 101 pushes the preset portion, so that one end, connected with the switch 3, of the swing rod 404 moves to trigger the switch 3. After the collision is eliminated, under a pushing force of the tension spring 403, the abutting part 101 is reset, and the first slopes 1031 of the limiting parts 103 in the cover 1 slide relatively with the second slopes 2011 of the matching parts 201, so that the cover 1 ascends to reset.

In the example of the disclosure, the mode that the tension spring 403 and the swing rod 404 are matched to trigger the switch 3 has higher triggering precision and better sensitivity than the mode of the torsion spring 401.

In an example, as shown in FIG. 1 to FIG. 7, in the collision detection apparatus, the switch 3 includes a trigger structure 301, and the other end of the elastic assembly 4 is in abutting connection with the trigger structure 301.

In an example, as shown in FIG. 4 and FIG. 6, the switch 3 is a mechanical switch, and the trigger structure 301 may be a toggle trigger lever of the switch 3. In a collision scenario, the elastic assembly 4 will push the trigger structure 301 to trigger the switch 3. After the switch 3 is triggered, the switch 3 reports the collision event to the processor or the main controller of the sweeping robot.

In an example, as shown in FIG. 1 to FIG. 7, in the collision detection apparatus of the present example, the switch 3 includes a light emitting part 302 and a light receiving part 303, and a light path of the light emitting part 302 is opposite to a light path of the light receiving part 303; and under the state that the cover 1 has a collision and moves in the set direction, the other end of the elastic assembly 4 moves to a position between the light emitting part 302 and the light receiving part 303 so as to cut off the light paths.

In the present example, as shown in FIG. 7, the switch 3 is a photoelectric switch, such as an infrared light cut-off switch. The infrared light cut-off switch may be in a U shape, one arm of the U shape is provided with the light emitting part 302, and the other arm is provided with the light receiving part 303. In the collision scenario, the elastic assembly 4 will push the swing rod 404, and one end, away from the preset portion, of the swing rod 404 moves to a notch of the U-shaped structure to cut off the light emitting part 302 and the light receiving part 303 so as to trigger the switch 3. After the switch 3 is triggered, the switch 3 reports the collision event to the processor or the main controller of the sweeping robot.

In the example of the disclosure, the photoelectric switch requires less force for triggering, and the swing rod 404 moves to cut off the light paths to achieve triggering, so the sensitivity is further improved.

In an example, the disclosure further provides a cleaning device, including the collision detection apparatus of any one of the foregoing examples.

Other implementation solutions of the disclosure will be apparent to those skilled in the art from consideration of the specification and practice of the disclosure herein. The disclosure is intended to cover any variations, uses, or adaptations of the disclosure following the general principles of the disclosure and including such departures from the disclosure as come within known or customary practice in the art. It is intended that the specification and examples be considered as examples merely, with a true scope of the disclosure being indicated by the following claims.

It will be appreciated that the disclosure is not limited to the exact construction that has been described above and illustrated in the accompanying drawings, and that various modifications and changes may be made without departing from the scope of the disclosure. It is intended that the scope of the disclosure merely be limited by the appended claims.

1. A collision detection apparatus, comprising:
a base;
a switch in the base;
an elastic assembly in the base, wherein one end of the elastic assembly is connected with the base, and an other end of the elastic assembly is connected with the switch; and
a cover movably connected with the base to move within a set range, wherein the cover has an abutting part, and the abutting part is clamped with a preset portion of the elastic assembly; wherein
under a state that the cover has a collision and moves in a set direction, the abutting part is forced to push the preset portion, so as to drive the other end of the elastic assembly to trigger the switch, and the switch is configured to report a collision event when being triggered.

2. The collision detection apparatus according to claim 1, wherein a plurality of limiting holes are in a bottom plate of the cover, and the cover is movably connected with the base through the plurality of limiting holes.

3. The collision detection apparatus according to claim 2, wherein the plurality of limiting holes extend by a first distance in a first direction, so that the cover can move by the first distance in the first direction.

4. The collision detection apparatus according to claim 2, further comprising first fixing pieces; wherein
ends of the first fixing pieces are assembled with the limiting holes, and other ends of the first fixing pieces are fixedly connected with the base, so as to connect the cover with the base.

5. The collision detection apparatus according to claim 1, wherein the abutting part comprises an inclined unit, wherein under the state that the cover has a collision and moves in the set direction, the inclined unit is configured to push the preset portion.

6. The collision detection apparatus according to claim 1, wherein the cover comprises a bottom plate, the bottom plate has a limiting part, and one end of the limiting part has a first slope;
a matching part is at a position, corresponding to the limiting part, of the base, and one end of the matching part has a second slope; and the first slope is in sliding contact with the second slope, so that the limiting part is in sliding connection with the matching part.

7. The collision detection apparatus according to claim 6, wherein the abutting part is at a position, at a first predetermined distance from a first side of the bottom plate, of the bottom plate; and
the limiting part is at a position, at a second predetermined distance from a second side of the bottom plate, of the bottom plate and/or at a position, at a third predetermined distance from a third side of the bottom plate, of the bottom plate, the second side and the third side are oppositely disposed, and the first slope is at one end, away from the abutting part, of the limiting part.

8. The collision detection apparatus according to claim 1, wherein the elastic assembly comprises a torsion spring and a second fixing piece; the second fixing piece is vertically fixed on the base, and the torsion spring is connected to the second fixing piece; and
the preset portion is a connection portion of the torsion spring and the second fixing piece.

9. The collision detection apparatus according to claim 8, wherein the torsion spring comprises a main body part, a first arm, and a second arm;
the main body part sleeves the second fixing piece, one end of the first arm is connected with one end of the main body part, and an other end of the first arm is connected with the base; and one end of the second arm is connected with an other end of the main body part, and an other end of the second arm is in contact connection with the switch.

10. The collision detection apparatus according to claim 9, wherein a first support part and a second support part are on the base, the first arm is fixedly connected with the first support part, and a set position of the second arm is in overlap joint with the second support part.

11. The collision detection apparatus according to claim 1, wherein the elastic assembly comprises a tension spring and a swing rod;
one end of the tension spring is fixedly connected with the base, an other end of the tension spring is connected with one end of the swing rod, and an other end of the swing rod is connected with the switch; and
the preset portion is a connection portion of the tension spring and the swing rod.

12. The collision detection apparatus according to claim 1, wherein the switch comprises a trigger structure, and the other end of the elastic assembly is in abutting connection with the trigger structure.

13. The collision detection apparatus according to claim 1, wherein the switch comprises a light emitting part and a light receiving part, and a light path of the light emitting part is opposite to a light path of the light receiving part; and
under the state that the cover has a collision and moves in the set direction, the other end of the elastic assembly moves to a position between the light emitting part and the light receiving part so as to cut off the light path.

14. A cleaning device, comprising a collision detection apparatus, the collision detection apparatus comprises:
a base;
a switch in the base;
an elastic assembly in the base, wherein one end of the elastic assembly is connected with the base, and an other end of the elastic assembly is connected with the switch; and
a cover movably connected with the base to move within a set range, wherein the cover has an abutting part, and the abutting part is clamped with a preset portion of the elastic assembly; wherein
under a state that the cover has a collision and moves in a set direction, the abutting part is forced to push the preset portion, so as to drive the other end of the elastic assembly to trigger the switch, and the switch is configured to report a collision event when being triggered.

15. The cleaning device according to claim 14, wherein a plurality of limiting holes are in a bottom plate of the cover, and the cover is movably connected with the base through the plurality of limiting holes.

16. The cleaning device according to claim 14, wherein the abutting part comprises an inclined unit, wherein under the state that the cover has a collision and moves in the set direction, the inclined unit is configured to push the preset portion.

17. The cleaning device according to claim 14, wherein the cover comprises a bottom plate, the bottom plate has a limiting part, and one end of the limiting part has a first slope; and
a matching part is at a position, corresponding to the limiting part, of the base, and one end of the matching part has a second slope; and the first slope is in sliding contact with the second slope, so that the limiting part is in sliding connection with the matching part.

18. The cleaning device according to claim 14, wherein the elastic assembly comprises a torsion spring and a second fixing piece; the second fixing piece is vertically fixed on the base, and the torsion spring is connected to the second fixing piece; and
the preset portion is a connection portion of the torsion spring and the second fixing piece.

19. The cleaning device according to claim 14, wherein the elastic assembly comprises a tension spring and a swing rod;
one end of the tension spring is fixedly connected with the base, an other end of the tension spring is connected with one end of the swing rod, and an other end of the swing rod is connected with the switch; and
the preset portion is a connection portion of the tension spring and the swing rod.

20. The cleaning device according to claim 14, wherein the switch comprises a light emitting part and a light receiving part, and a light path of the light emitting part is opposite to a light path of the light receiving part; and
under the state that the cover has a collision and moves in the set direction, the other end of the elastic assembly moves to a position between the light emitting part and the light receiving part so as to cut off the light path.
